(19) United States
(12) Patent Application Publication
(10) Pub. No.: US 2006/0249263 A1
(43) Pub. Date: Nov. 9, 2006

(54) Headrail lift cord structure for blinds

(75) Inventor: Wen Ying Liang, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/189,863

(22) Filed: Jul. 27, 2005

(30) Foreign Application Priority Data
May 4, 2005 (TW) 094207112

(51) Int. Cl. E06B 9/30

(52) U.S. Cl. 160/168.1 R

(57) ABSTRACT

A headrail lift cord structure for blinds comprises a headrail with an accommodating groove and abutment sections defining thereon for the limiting location of a positioned seat and an adjusting seat therein wherein the positioned seat has pivoting walls with insert grooves for the mounting of a roller, and a first cord passage for the extension there-through of a first lift cord thereby. The adjusting seat is made up of a support portion and a branch portion with a passing space situated there-between. Therefore, a second lift cord led through a blind body can be sequentially guided through a branch roller of the branch portion, the passing space, and a support roller of the support portion before running through a pulley seat with a minimum angle formed therewith, permitting smooth and effortless pulling operation of the second lift cord without being awkwardly jammed or blocked in the application thereof.

### BACKGROUND OF THE INVENTION

The present invention is related to a headrail lift cord structure for blinds, comprising a headrail with an accommodating groove and abutment sections defining thereon for the limiting location of a positioned seat and an adjusting seat therein wherein the adjusting seat is made up of a support portion and a branch portion with a passing space situated there-between; therefore, a second lift cord led through a blind body can be sequentially guided through a branch roller of the branch portion, the passing space, and a support roller of the support portion before running through a pulley seat with a minimum angle formed there-between, permitting smooth and effortless pulling operation of the second lift cord without being awkwardly jammed or blocked in the application thereof.

Please refer to FIG. 1. A conventional headrail lift cord structure for blinds is made up of a headrail 10 having a set of first and second positioned seats 11, 12 symmetrically accommodated at predetermined positions of both lateral sides therein wherein the first and second positioned seats 11, 12 are respectively equipped with a set of first and second pivoting boards 111, 121 with first and second insert slots defining thereon for the horizontal mounting of first and second rollers 13, 14 with inserting posts 131, 141 disposed at both ends thereon respectively. Besides, the first and second positioned seats 11, 12 are respectively provided with a first cord passage 15 and a second cord passage 16 for the extension there-through of a first lift cord 17 and a second lift cord 18 that are respectively guided to run through a roller wheel 191 of a pulley seat 19 and an opening 192 disposed at one end of the headrail 10 thereon.

There are some drawbacks to such conventional headrail lift cord structure for blinds. First, the second lift cord 18 is guided from top to bottom to directly wind around the second roller 14 and sequentially run through the roller wheel 191 of the pulley seat 19 and the opening 192 thereof, permitting a big angle A wider than 30° formed between the second lift cord 18 and the pulley seat 19 that can hinder a smooth pulling operation of the second lift cord 18 thereof. Second, in the state of pulling operation thereof, the second lift cord 18 tends to rub against the second roller 14 with an interfering end A′ formed at the contact area thereof to generate jamming and blocking effects thereby, which makes the second lift cord 18 rather hard and pain-taking to draw in application thereof.

Pleases refer to FIG. 2. A second headrail lift cord structure for blinds includes a headrail 20 having a set of first and second positioned seats 21, 22 accommodated at predetermined positions of both lateral sides therein. The first positioned seat 21 is equipped with a set of first pivoting boards 211 with first insert slots 212 defining thereon for a first roller 23 having inserting posts 231 protruding at both ends thereon to horizontally mount thereto, and the second positioned seat 22 has second pivoting boards 221 with second insert slots 222 disposed thereon for the registration therewith of inserting posts 241 of a second roller 24 horizontally tilted into an angle. Besides, the first and second positioned seats 21, 22 are respectively provided with a first cord passage 25 and a second cord passage 26 for the extension there-through of a first lift cord 27 and a second lift cord 28 respectively guided to run through a roller wheel 291 of a pulley seat 29 and an opening 292 disposed at one end of the headrail 20 thereon.

However, the second conventional headrail lift cord structure for blinds also contains some disadvantages. First, the second lift cord 28 is guided from top to bottom to directly wind around the second roller 24 and sequentially run through the roller wheel 291 of the pulley seat 29 and the opening 292 thereof, permitting a rather big angle A formed between the second lift cord 28 and the pulley seat 29 that can hinder a smooth pulling operation of the second lift cord 28 thereof. Second, in the state of pulling operation thereof, the second lift cord 28 tends to rub against the second roller 24 with an interfering end A′ formed at the contact area thereof to generate jamming and blocking effects thereby, which can result in an awkward and difficult pulling operation of the second lift cord 28 thereof.

### SUMMARY OF THE PRESENT INVENTION

It is, therefore, the primary purpose of the present invention to provide a headrail lift cord structure for blinds, comprising a headrail with a positioned seat and an adjusting seat accommodated therein wherein the adjusting seat is made up of a support portion and a branch portion with a passing space situated there-between; therefore, a second lift cord led through a blind body can be sequentially guided through a branch roller of the branch portion, the passing space, and a support roller of the support portion before running through a pulley seat with a minimum angle formed there-between so that the second lift cord can be easily and smoothly pulled without being awkwardly jammed or blocked in the operation thereof, achieving effortless and convenient application of the present invention thereof.

### BRIEF DESCRIPTION OF THE DRAWINGS

FIG. 1 is an assembled flat view of a conventional headrail lift cord structure.

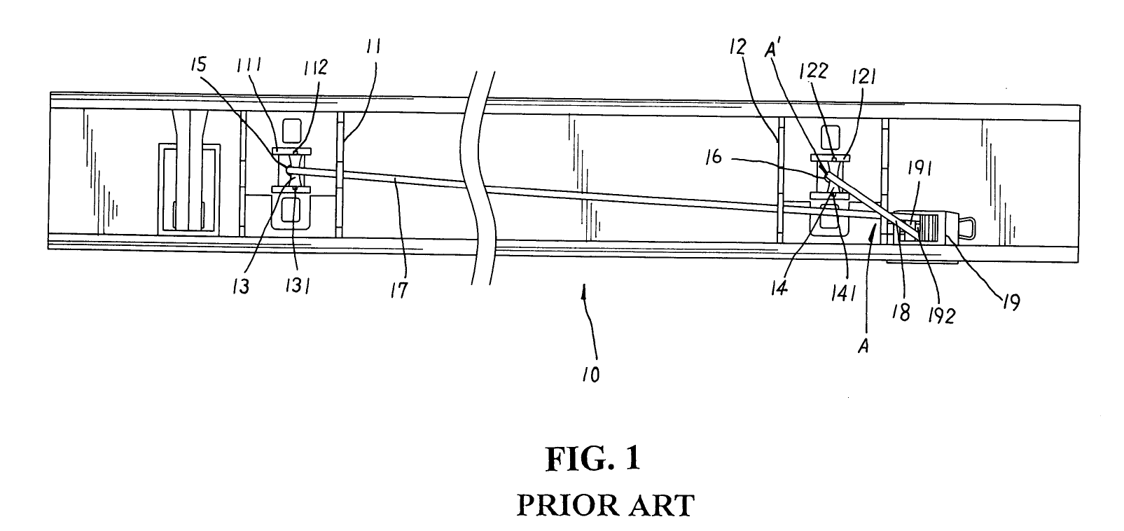

FIG. 2 is an assembled flat view of a second conventional headrail lift cord structure.

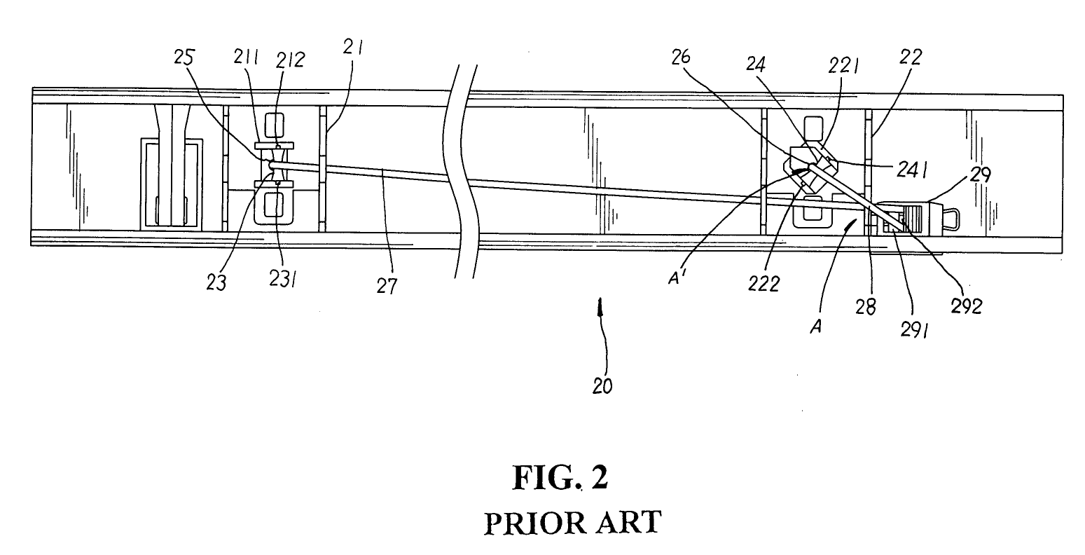

FIG. 3 is an exploded perspective view of the present invention.

FIG. 4 is an assembled perspective view of the present invention.

FIG. 5 is an assembled flat view of the present invention.

FIG. 6 is a diagram showing a blind body of the present invention folded up in operation.

FIG. 7 is an assembled flat view of another embodiment of the present invention.

FIG. 8 is an assembled flat view of a third embodiment of the present invention.

### DETAILED DESCRIPTION OF THE PREFERRED EMBODIMENTS

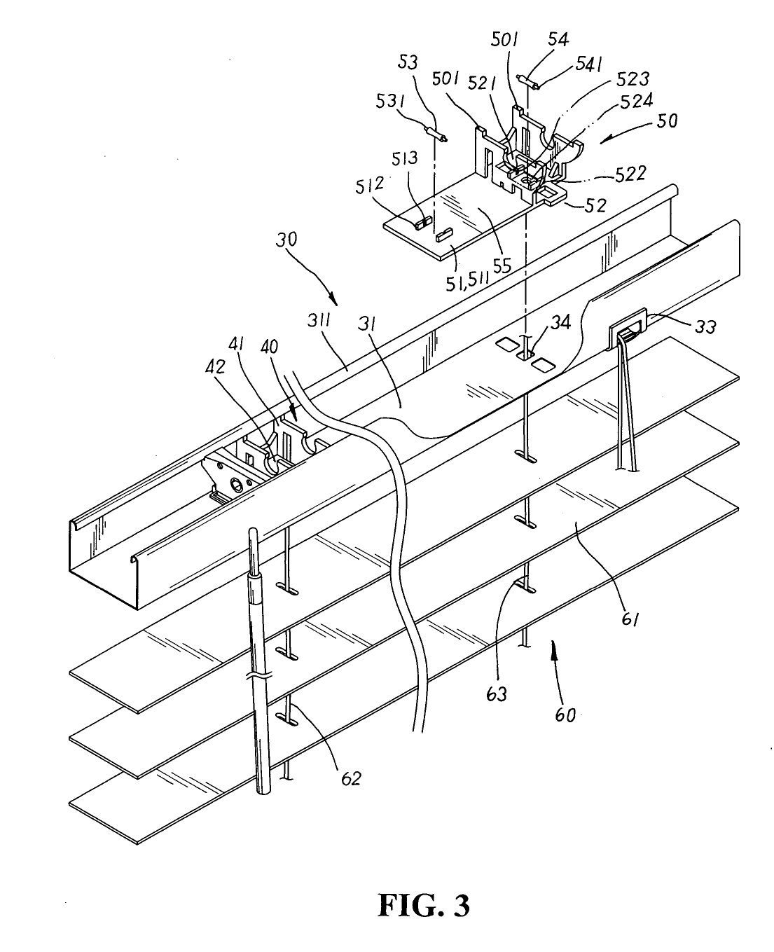

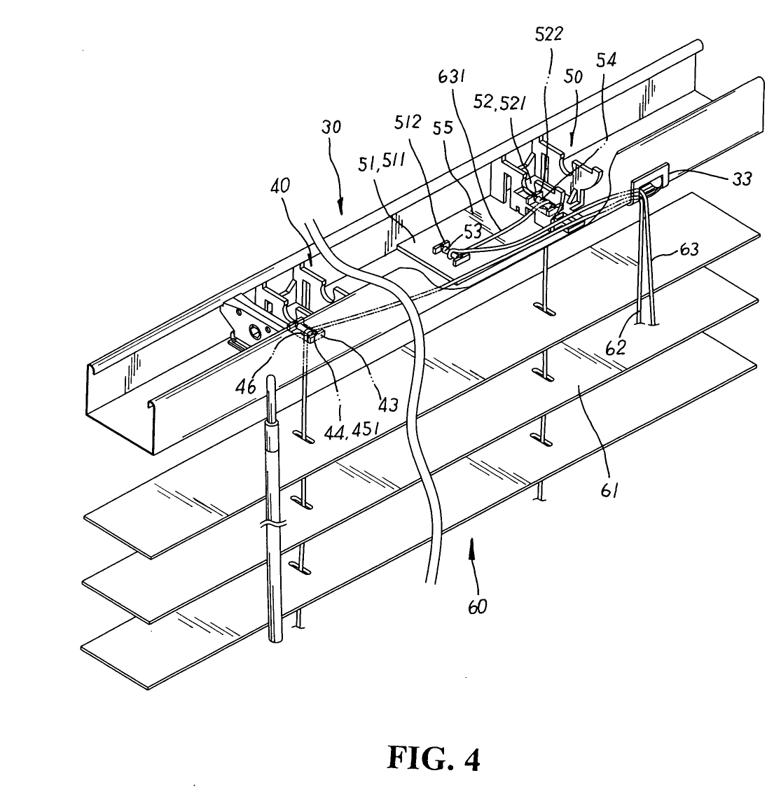

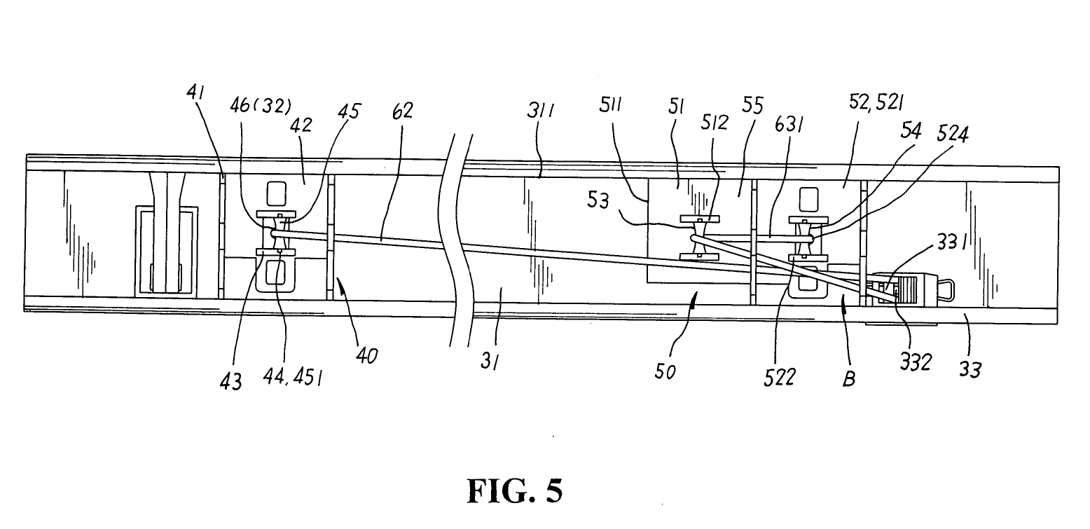

Please refer to FIG. 3 showing an exploded perspective view of the present invention (accompanied by FIGS. 4, 5). The present invention is related to a headrail lift cord structure for blinds, comprising a headrail 30 with an accommodating groove 31 and abutment sections 311 defining thereon for the limiting location of first abutting ends 41 of a positioned seat 40 and second abutting ends 501 of an adjusting seat 50 therein respectively. The positioned seat 40 includes a set of pivoting walls 43, each having an insert groove 44 defining thereon, symmetrically disposed at predetermined positions of a base 42 thereon for the mounting of a roller 45 with opposite inserting posts 451 protruding thereon, and a first cord passage 46 disposed at one side of the base 42 thereon to precisely match and communicate with a first thru-hole 32 of the headrail 30 for the extension there-through of a first lift cord 62 guided through a blind body 61 to sequentially run through a roller wheel 331 of a pulley seat 33 and an opening 332 disposed at one end of the headrail 30 thereon. The adjusting seat 50 is made up of a support portion 51 with a support base 511 and a branch portion 52 with a branch base 521 disposed at both sides thereof. The branch portion 52 has a set of elongated pivoting plates 522, each defined by an engaged groove 523 thereon, symmetrically protruding at predetermined positions of the branch base 521 thereon, and a second cord passage 524 disposed at one side of the base board 521 thereon to reciprocally communicate with a second thru-hole 34 of the headrail 30 thereby. The support portion 51 thereof is equipped with a set of elongated pivoting boards 512, each defined by a fitted groove 513 thereon, symmetrically extending at predetermined positions of the support base 511 thereon. A support roller 53 with opposite fitting rods 531 extending at both ends thereon and a branch roller 54 with opposite engaging rods 541 disposed thereon are horizontally mounted to the fitted grooves 513 of the elongated pivoting boards 512 and the engaged grooves 523 of the elongated pivoting plates 522 thereof respectively. The support portion 51 and the branch portion 52 of the adjusting seat 50 can be reciprocally connected and joined to both adjacent sides of a passing space 55 of an appropriate width situated there-between. Therefore, a second lift cord 63 led through the blind body 61 of a blind 60 is sequentially threaded through the second thru-hole 34 of the headrail 30 and the second cord passage 524 of the branch portion 52 to run through the branch roller 54 and draw a straight-line guiding section 631 that is further stretched to extend through the passing space 55 and wind around the support roller 53 thereby. Then, the second lift cord 63 is guided to run through the roller wheel 331 of the pulley seat 33 and the opening 332 thereof, permitting a minimum angle B smaller than 30° to form between the second lift cord 63 and the pulley seat 33 thereof.

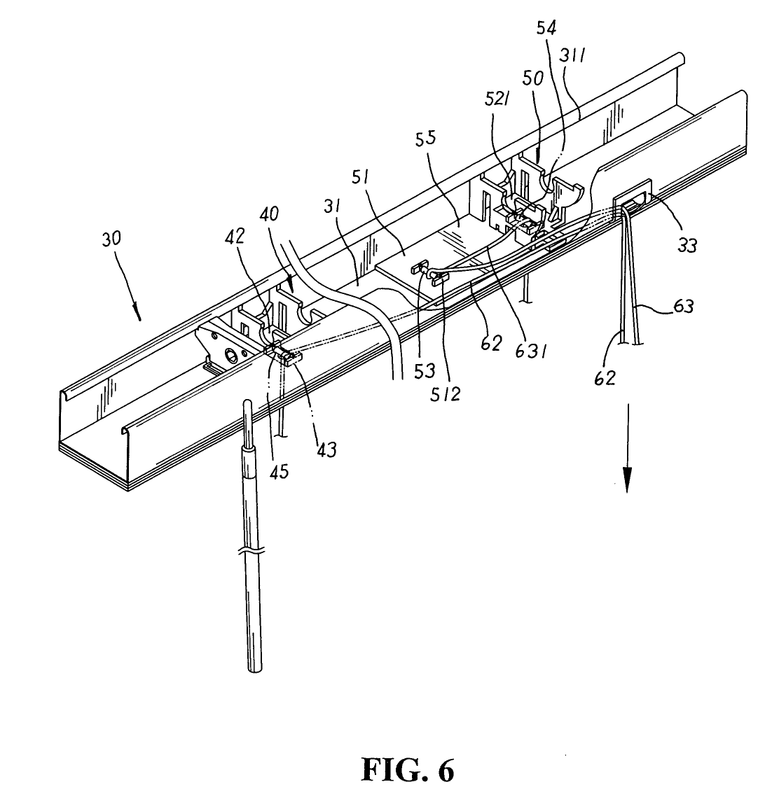

In application, the first and the second lift cords 62, 63 of the blind 60 are pulled downwards to actuate the movement of the blind body 61 thereby. Via the minimum angle B formed between the second lift cord 63 and the pulley seat 33 as well as via the guiding section 631 drawing a straight line and sliding between the branch roller 54 and the support roller 53 thereof to provide smooth guiding effect thereby, the blind body 61 of the blind 60 can be easily and speedily folded up from a state of expansion (as shown in FIG. 4) to that of collection (as shown in FIG. 6) without the second lift cord 63 being awkwardly jammed or blocked in the operation thereof, achieving more effortless and convenient application of the present invention.

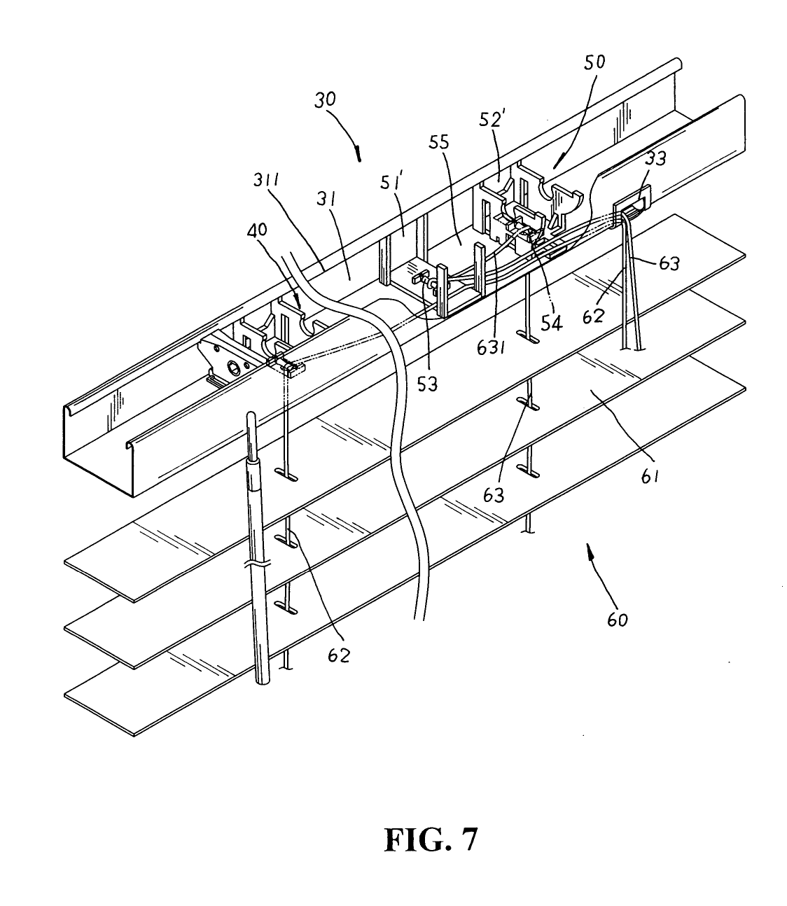

Please refer to FIG. 7 showing another embodiment of the present invention. The adjusting seat 50 thereof can also include a support portion 51′ and a branch portion 52′ that are individually positioned and separated by a passing space 55 of an appropriate width disposed there-between.

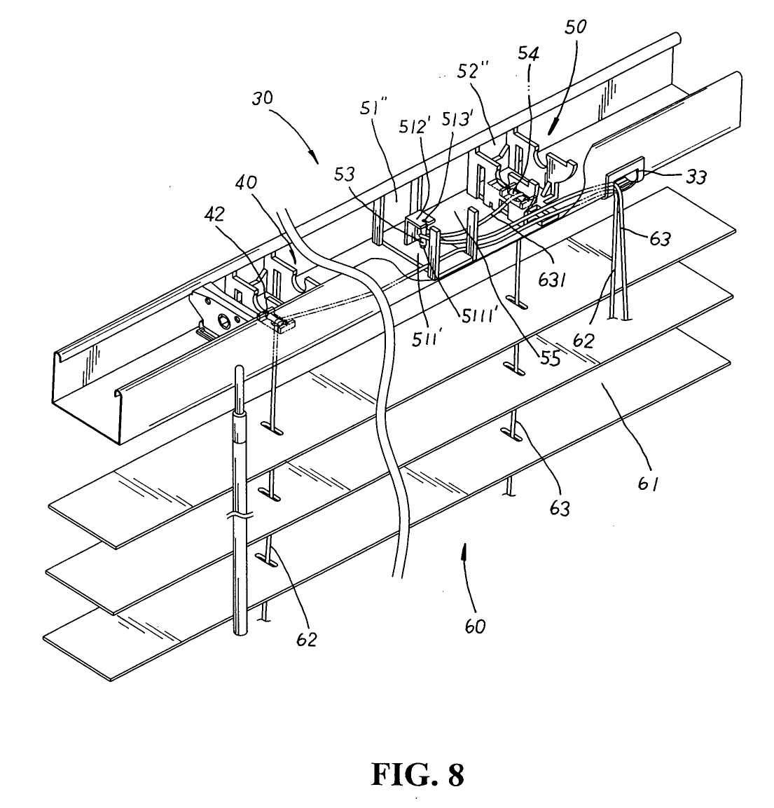

Please refer to FIG. 8 showing a third embodiment of the present invention. The adjusting seat 50 thereof can also have a support portion 51″ and a branch portion 52″ that are individually positioned at both adjacent sides of the passing space 55 thereof. And the support portion 51″ is equipped with a support base 511″ with a fitted cavity 5111″ disposed at an appropriate position thereon correspondingly opposite to a fitted groove 513″ defining one side of an inverted L-shaped pivoting board 512″ for the registration of the fitting rods 531 of the support roller 53 therewith respectively so as to mount the support roller 53 vertically between the support base 511″ and the pivoting board 512″ thereof for the winding of the second lift cord 63 guided to run through the roller wheel 331 of the pulley seat 33 and the opening 332 thereof respectively in a sequence.

What is claimed is:

1. A headrail lift cord structure for blinds, comprising a headrail with an accommodating groove and abutment sections defining thereon for the limiting location of first abutting ends of a positioned seat and second abutting ends of an adjusting seat therein respectively; the positioned seat includes a set of pivoting walls, each having an insert groove defining thereon, symmetrically disposed at predetermined positions of a base thereon for the mounting of a roller with opposite inserting posts protruding thereon, and a first cord passage disposed at one side of the base thereon to precisely match and communicate with a first thru-hole of the headrail for the extension there-through of a first lift cord guided through a blind body to run through a roller wheel of a pulley seat and an opening sequentially thereby; the adjusting seat is equipped with a branch portion with a branch base wherein the branch portion has a set of pivoting plates, each defined by an engaged groove thereon, symmetrically protruding at predetermined positions of the branch base thereon, and a second cord passage disposed thereon to reciprocally communicate with a second thru-hole of the headrail thereby; a branch roller is provided with opposite engaging rods extending at both ends thereon to register with the engaged grooves of the pivoting plates of the branch portion thereof respectively; the present invention being characterized by that,
at one side of the branch portion of the adjusting seat thereof being situated a support portion with a support base, and between the branch portion and the support portion thereof being situated a passing space wherein the support portion thereof is equipped with a set of pivoting boards, each defined by a fitted groove thereon, symmetrically extending at predetermined positions of the support base thereon, and a support roller with opposite fitting rods extending at both ends thereon is mounted to the fitted grooves of the pivoting boards thereof; therefore, a second lift cord led through the blind body of a blind is sequentially threaded through the second thru-hole of the headrail and the second cord passage of the branch portion to run through the branch roller and form a guiding section that is stretched to extend through the passing space and wind around the support roller thereby; then, the second lift cord is guided to run through the roller wheel of the pulley seat and the opening thereof with a minimum angle formed between the second lift cord and the pulley seat thereof so that the second lift cord can be easily and smoothly pulled without being awkwardly jammed or blocked in the operation thereof, achieving more effortless and convenient application of the present invention.

2. The headrail lift cord structure for blinds as claimed in claim 1 wherein the pivoting plates and boards of the branch portion and the support portion thereof are respectively made in the form of an elongated block.

3. The headrail lift cord structure for blinds as claimed in claim 1 wherein the passing space thereof is equipped with an appropriate width thereof.

4. The headrail lift cord structure for blinds as claimed in claim 1 wherein the support portion and the branch portion of the adjusting seat thereof can be reciprocally connected and joined to both adjacent sides of the passing space situated there-between.

5. The headrail lift cord structure for blinds as claimed in claim 1 wherein the support portion and the branch portion thereof can also be individually positioned at both adjacent sides of the passing space thereof.

6. The headrail lift cord structure for blinds as claimed in claim 1 wherein the support roller of the support portion can be horizontally mounted to the elongated pivoting boards thereon.

7. The headrail lift cord structure for blinds as claimed in claim 1 wherein the support roller of the support portion can also be vertically mounted thereto.

8. The headrail lift cord structure for blinds as claimed in claim 1 wherein the minimum angle formed by the second lift cord and the pulley seat thereof is smaller than 30 degree.

9. The headrail lift cord structure for blinds as claimed in claim 1 wherein the guiding section of the second lift cord is drawn in a straight line.
